(19) United States
(12) Patent Application Publication
(10) Pub. No.: US 2014/0270696 A1
(43) Pub. Date: Sep. 18, 2014

(54) MEDIA DEVICE WITH INTEGRATED STORAGE AND CHARGING FOR AN ACCESSORY DEVICE AND A UNIVERSAL REMOTE WITH BI-DIRECTIONAL RF AND UNI-DIRECTIONAL IR

(71) Applicant: Jano Banks, Cupertino, CA (US)

(72) Inventor: Jano Banks, Cupertino, CA (US)

(73) Assignee: AliphCom, San Francisco, CA (US)

(21) Appl. No.: 14/192,610

(22) Filed: Feb. 27, 2014

Related U.S. Application Data
(60) Provisional application No. 61/783,536, filed on Mar. 14, 2013.
(60) Provisional application No. 61/786,142, filed on Mar. 14, 2013.
(60) Provisional application No. 61/784,957, filed on Mar. 14, 2013.

(51) Int. Cl. H04N 21/422; H04N 21/41; H04N 5/44; H04N 5/63; H04N 5/765; H04N 5/85

(52) U.S. Cl. CPC H04N 21/42222; H04N 5/765; H04N 5/85; H04N 5/4403; H04N 5/63; H04N 21/4104; H04N 21/42203; H04N 21/42221; H04N 21/42225; H04N 21/42224; H04N 2005/4408; H04N 2005/4426; H04N 2005/443; H04N 2005/4428
USPC 386/231; 386/234

(57) ABSTRACT

An all-in-one consumer electronics (CE) media device may include a single IR/RF/Microphone handheld remote control for controlling and/or displaying information for all CE devices of a user(s) in concert with the all-in-one CE media device operative for playback of one or more media formats including but not limited to optical discs, audio and/or video, images, music, files, streaming media content, stored media content, and other content. The remote may be docked in the all-in-one CE media device and may have its power source recharged while docked. The remote may communicate with CE devices and/or Legacy devices using bi-directional RF and/or uni-directional IR signals. The all-in-one CE media device may wirelessly communicate RF signals to one or more speakers/transducers that are coupled with their own dedicated amplifiers (e.g., internal and/or external), and may wirelessly communicate with one or more microphones and/or speakers and apply algorithms for optimizing audio quality.

### CROSS-REFERENCE TO RELATED APPLICATIONS

This Application Claims Benefit and Right of Priority under 35 U.S.C. §119(e) to the Following U.S. Provisional Patent Applications: U.S. Provisional Patent Application Ser. No. 61/783,536, Filed on Mar. 14, 2013, having Attorney Docket No. ALI-032P, and Titled “Grand Central Architecture” ; U.S. Provisional Patent Application Ser. No. 61/786,142, Filed on Mar. 14, 2013, having Attorney Docket No. ALI-030P, and Titled “Media Device With Integrated Storage and Charging for an Accessory Device and a Universal Remote with Bi-Directional RF And Uni-Directional IR”; and U.S. Provisional Patent Application Ser. No. 61/784,957, Filed on Mar. 14, 2013, having Attorney Docket No. ALI-028P, and Titled “Input Stream Conversion and Programmable Voltage Regular for +5V Power Signal”, all of which are herein incorporated by reference in their entirety for all purposes.

### FIELD

Embodiments of the present application relate generally to electrical and electronic hardware, computer software, wired and wireless network communications, dedicated RF and IR remote controls, self-powered wireless speakers, and consumer electronic (CE) devices.

### BACKGROUND

Conventional consumer electronic (CCE) devices often require tasks such as setup, calibration, configuring, re-configuring, tweaking, and the like. Many users may experience difficulty in accomplishing those tasks. Difficulties encountered by typical users include but are not limited to connecting speaker wires between speakers in a stereo or multichannel sound system, running interconnect cables (e.g., RCA, XLR, USB, Ethernet, AC and/or DC Power, etc.) between various devices in the user's system, configuring audio equipment to optimize audio quality to match room acoustics, using multiple remote controls to operate different types or brands of CCE devices in a user's system, programming a universal remote to replace the multiple remote controls, and configuring audio and/or video equipment to play content in a format that is optimized for the user's equipment. Ideally, a CE device would minimize or completely eliminate some are all of the difficulties users experience with CCE devices.

Thus, there is a need for a CE device that eliminates as many wired connections as possible, especially between the CE device and speakers it plays back through, that eliminates the multiple remote controls with a single remote control, that configures other CE devices to match room acoustics, and that automatically plays content in a format that is optimized for the user's various CE devices.

### BRIEF DESCRIPTION OF THE DRAWINGS

Various embodiments or examples (“examples”) of the present application are disclosed in the following detailed description and the accompanying drawings. The drawings are not necessarily to scale:

FIG. 1 depicts one example of grand central architecture according to an embodiment of the present application;

FIG. 2 depicts one example of a block diagram for an all-in-one consumer electronics (CE) media player according to an embodiment of the present application;

FIG. 3 depicts one example of a flow diagram for a process for optimizing output from an all-in-one CE media player based on content from an Optical Disc (OD) according to an embodiment of the present application;

FIG. 4 depicts an example of a system including a wireless RF & IR remote including microphone input for configuring wireless speakers to optimize audio quality to match room acoustics according to embodiments of the present application;

FIG. 5 depicts an example of wireless communications between CE devices, a wireless RF & IR remote, and an all-in-one CE media player according to an embodiment of the present application;

FIG. 6 depicts an example flow diagram for operation of a wireless RF & IR remote in conjunction with an all-in-one CE media player according to an embodiment of the present application;

FIG. 7 depicts one example of an auto-run scenario according to an embodiment of the present application;

FIG. 8 depicts one example of a block diagram for a conventional +5V Power Signal configuration for a HDMI interface;

FIG. 9 depicts one example of a block diagram for an enable/disable +5V power signal triggered by an enable input for a HDMI interface according to an embodiment of the present application;

FIG. 10 depicts one example of a flow diagram for a sourced +5V signal according to an embodiment of the present application;

FIG. 11 depicts analog and digital inputs and outputs for audio and video signals, a legend for the inputs and outputs, and a priority ranking for those inputs and outputs according to an embodiment of the present application;

FIGS. 12A-12C depict different examples of Analog and Digital input stream conversion according to an embodiment of the present application;

FIG. 13 depicts one example of input and output streams for a stream converter according to an embodiment of the present application;

FIG. 14 depicts a diagram of a conventional remote control and a conventional host CE device;

FIG. 15 depicts one example of CE device including an integrated dock and remote control charger for a universal remote control according to an embodiment of the present application;

FIG. 16 depicts a universal remote control docked in an integrated dock and remote control charger according to an embodiment of the present application;

FIG. 17 depicts one example of a conventional IR remote control transmitting IR commands to a conventional host CE device;

FIG. 18 depicts one example of a universal remote in RF communication with a host CE device according to an embodiment of the present application;

FIG. 19 depicts one example of a universal remote in RF communication with a host CE device and IR communication with a legacy CE device according to an embodiment of the present application; and

FIG. 20 depicts one example of a block diagram for a universal remote including IR and RF links for communication with CE devices and Legacy devices according to an embodiment of the present application.

### DETAILED DESCRIPTION

Various embodiments or examples may be implemented in numerous ways, including as a system, a process, a method, an apparatus, a user interface, or a series of executable program instructions included on a non-transitory computer readable medium. Such as a non-transitory computer readable medium or a computer network where the program instructions are sent over optical, electronic, or wireless communication links and stored in a non-transitory computer readable medium. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

As will be described in greater detail below, a grand central architecture for CE devices may simplify setup and use of CE devices and may uses a variety of technologies to address main areas of difficulty consumers and other users have with conventional CE devices, including but not limited to: connecting wires (e.g., speaker cables) between amplifiers and speakers; using a plurality of remote controls to control diverse CE devices in a user's system; configuring audio/video equipment to optimize audio quality to match room acoustics; and configuring audio/video equipment to play content in a format that is optimized for a user's equipment, just to name a few.

The grand central architecture for CE devices may include a single remote control for controlling and/or displaying information for all CE devices of a user(s) in concert with an all-in-one CE media device (e.g., a media player) configured for playback of a wide variety of optical disc formats that include audio and/or video, image, music, files, and other content as well as streaming media content and stored media content (e.g., on HDD, SSD, NAS, RAID, Flash Memory, media in the Cloud, media on the Internet, downloaded media files, etc.). The all-in-one CE media device does not include internal and/or dedicated power amplifiers to drive speakers or other types of transducers. The all-in-one CE media device may wirelessly communicate RF signals to one or more speakers/transducers that either include their own dedicated internal power amplifiers or are connected with (e.g., hard wired to) an external power amplifier. Alternatively, the all-in-one CE media device may wirelessly communicate RF signals to a receiving device that is connected with an amplifier that drives a speaker/transducer.

The single remote is specifically designed (e.g., by the same manufacture/designer of the all-in-one CE media device) to communicate wirelessly using RF and/or IR with the all-in-one CE media device and other media devices or systems of a user(s). The all-in-one CE media device may be configured to include an integrated storage location (e.g., a receptacle, dock, holster, mount, shelf, stand or otherwise) for the single remote and may be configured to electrically recharge a power system (e.g., a battery) of the single remote when the single remote is positioned in the integrated storage location. While positioned in the integrated storage location, the single remote may optionally have software, firmware, code, tables, data, or the like upgraded, updated, installed, or other. For example, IR and/or RF codes for devices in a user(s) system may be updated by installing new codes. In other examples, updates may be achieved by wireless communications between the single remote and the all-in-one CE media device. The single remote may include an integral microphone (e.g., an internal microphone) or an input for an external microphone (e.g., via a 3.5 mm mini jack or ¼ inch jack, or other).

The all-in-one CE media device may include an optical drive configured to read data from optical discs and a system configured to analyze media content on the optical disc. The system is operative to initiate an “auto-run” on the all-in-one CE media device such that the media content on the optical disc is output to the user's CE devices in an optimized manner without the user having to provide any input to the all-in-one CE media device. Examples of auto-run include but are not limited to playing back audio content in a format optimized for a user's CE devices/equipment, playing back video content in a format optimized for a user's CE devices/equipment, playing back audio/video content in a format optimized for a user's CE devices/equipment, selecting a content in an analog or digital format based on capabilities of the user's CE devices/equipment and/or which format will provide the best performance, selecting content based on resolution capability of the user's CE devices/equipment (e.g., high resolution video and/or audio vs. lower resolution video and/or audio or compressed vs. uncompressed content, or lossless vs. lossy content, etc.), display format for video based on the user's display capability (e.g., aspect ratios such as 16:9, anamorphic, widescreen, 4:3, etc.), and progressive scan or interlaced video content.

The all-in-one CE media device may wirelessly communicate with one or more speakers (e.g., in a surround sound system) and one or more microphones to apply algorithms for adjusting one or more parameters for any one of the speakers to optimize audio quality to match room acoustics and/or compensate for acoustic anomalies caused by interaction between the speakers and the structure of the room the speakers are located in (e.g., room resonances, frequency response anomalies, time delay between speakers, etc.). In some applications, the all-in-one CE media device may wirelessly communicate with one or more speakers that include an integral microphone.

The all-in-one CE media device may wirelessly communicate with one or the all-in-one CE media device may comprise a system of many components that includes but is not limited to: an all-in-one CE media player configured to play a variety of optical disc formats (e.g., DVD, DVD-A, DVD-RAM, DVD-R, DVD±R, DVD±RW, DVD-ROM, Blu-Ray, SACD, Hybrid SACD, CD-R, CD-ROM, CD, DDCD-ROM, HD DVD, DIVX, VCD, Super Video CD, and their equivalents); one or more wireless speakers (e.g., surround sound, multi-channel, or stereo speakers) that wirelessly communicate with the all-in-one CE media player and optionally each speaker including an integral microphone in wireless communication with the all-in-one CE media player; and a wireless remote control that wirelessly communicates with the all-in-one CE media player and with other CE devices in a user's system and optionally including in integral microphone that may wirelessly communicate with the all-in-one CE media player.

Attention is now directed to FIG. 1 where one example of grand central architecture 199 including an all-in-one consumer electronic (CE) media player 100 (media player 100 herein after) that does not include power amplifiers and configured to playback content from a variety of optical discs (OD) 102 via an optical drive that receives 102i the OD 102 via a door, slot loader, tray, etc. denoted as 101, is depicted. Grand central architecture 199 may include one or more wireless speakers 160 denoted here as 160a-160n with wireless RF communications 166 between speakers 160 and media player 100 occurring via RF systems 120 and 162. Each speaker 160 includes internal amplifiers 161, speakers 168, a controller CNTL 163, a power system PWR 169, and optionally a microphone 165 and associated preamplifier PRE 167. PWR 169 may derive electrical power from a battery source (e.g., a rechargeable battery) and/or an eternal power source 169p (e.g., AC power). Grand central architecture 199 may include one or more CE devices 170 (e.g., a HDTV) and the CE device 170 may include RF system 172 for wireless communications 186 with other CE devices, media device 100, a wireless router 190, etc. Grand central architecture 199 may include a universal remote 150 having wireless IR 158, RF 156, or both communication capability with CE devices (e.g., CE device 170, speakers 160) and media player 100. Universal remote 150 may include a microphone 155 configured to receive sound 140 as will be described in detail below. Media device 100 may include buttons, key pads, displays, annunciators, or the like denoted as 121 and may include an IR receiver 135 for receiving IR commands 138 from an IR remote (e.g., remote 150). Media device 100 may include a plurality of audio and video inputs and outputs for analog and digital signals. CE devices, such as CE device 170 may be connected 171 with media device 100 using HDMI or other types of interfaces. Speakers 160 generate sound 142 based on audio content served from media player 100 and optionally for tuning room acoustics using universal remote 150. Optional microphones 165 may be used in the tuning of room acoustics acting individually or in concert with universal remote 150. Sound (e.g., 142) from one or more of the speakers 160 that is received 140 by microphones 165 during the tuning process may be used to effectuate tuning room acoustics. Content or other data may be wirelessly accessed 196 from a source 190 such as the Cloud, Internet, Server, NAS, or web site, for example.

FIG. 2 depicts one example of a block diagram 200 for media player 100. Media player 100 includes an integrated A/V controller 202 for processing, content signal decoding, content signal encoding, A/V switching, and handling A/V signals (203, 205) between an Inputs system 108 having one or more inputs 208a-208n and an Outputs system 210 having one or more outputs 210a-210n. NV controller 202 may include A-to-D converters, D-to-A converters, or both for processing content. Wireless transceiver 204 is coupled with RF system 120 to enable wireless communications with other RF enabled devices such as WiFi/WiMax networks, and Bluetooth (BT) devices, for example. Outputs system 210 may direct content to wireless transceiver 204 for playback or other on another wireless device, such as speakers 160 of FIG. 1, for example. Content (e.g., audio, video, data, etc.) may be received by media device 100 via Inputs system 208, Optical drive 212, wireless transceiver 204, or any combination of those systems. Optionally, IR receiver 135 may be used for receiving IR commands from a remote control that includes IR wireless capability, such as remote 150 or other. Processor 206 may be used as “traffic cop” to direct various operations and functions within media player 100. In some examples, processor 206 is a low cost, modest performance, general purpose processor selected to provide capabilities similar to that of a media center PC but at a much lower cost. For example, a low cost micro controller (μC) or microprocessor (μP) may be used for processor 206. In some examples, a majority of the processing workload and power reside in A/V controller 202 such that a powerful and expensive processor need not be used for processor 206. A/V controller 202 may include at least one digital signal processor (DSP) and may include one or more CPU's (e.g., dual core, quad core, etc. processors). Optical drive 212 may be configured to read a variety of OD formats including but not limited to DVD, DVD-A, DVD-RAM, DVD-R, DVD±R, DVD±RW, DVD-ROM, Blu-Ray, SACD, Hybrid SACD, CD-R, CD-ROM, CD, DDCD-ROM, HD DVD, DIVX, VCD, Super Video CD, and their equivalents. Optical drive 212 may also be configured to write data/content to a variety of writeable OD formats. Optical drive 212 may be configured to both read and write a variety of OD formats.

FIG. 3 depicts one example of a flow diagram 300 for a process for optimizing output from a media player 100 based on content from OD 102. At a stage 302 the OD 102 is inserted into media player 100. At a stage 304 the OD 102 is analyzed to determine the content present on the OD 102. At stage 306 if the content is audio content, then a YES branch is taken to a stage 310. At stage 310, capabilities of audio devices connected with media player 100 are determined. At a stage 312 audio output of the audio content is optimized for a selected audio device that is connected with media player 100. As one example, if the audio content is a multi-channel surround sound track, then the audio output may be optimized for surround sound playback (e.g., using DTS® or other multi-channel format) using multiple speaker channels (e.g., wireless speakers 160a-160n). On the other hand, if the content is music in stereo, then audio output may be optimized for two-channel playback over a pair of wireless speakers 160 (e.g., left and right channels).

If the content is not audio content, then a NO branch is taken to a stage 314. At the stage 314 if the content is video content, then a YES branch is taken to a stage 316. At stage 316, capabilities of video devices connected with media player 100 are determined. At a stage 318 video output of the video content is optimized for a selected video device that is connected with media player 100. For example, if the video content on OD 102 comprises high-definition (HD) video at 1080p, then video output may be optimized for a HDTV video device over an HDMI connection with media player 100. On the other hand, if the content on OD 102 comprises standard definition video at 720p, then video output may be optimized for a standard definition TV over a composite video connection with media player 100 or the content may be up-sampled to a higher resolution for a HDTV video device over an HDMI connection or component video connection with media player 100.

If the content is not audio or video content, then a NO branch is taken to a stage 320 where a determination is made as to whether or not the OD 102 comprises other content that may be processed by media device 100. If the media device can process the other content, a YES branch is taken to a stage 322 where the capabilities of other types of connected devices are determined. At a stage 324 output of the other content is optimized for a selected other type of device. For example, the content on OD 102 may comprise JPEG or RAW format digital images and output of the content may be optimized for display on a high resolution display device such as a Plasma, OLED, or LED backlit LCD display.

If the content is not audio, video, or other, then a NO branch may be taken to a stage 326 where a decision to terminate analysis is made. If the YES branch is taken, then the flow 300 may terminate. If the NO branch is taken, then a decision to reject the OD 102 may be made at a stage 328. If the YES branch is taken, then the flow 300 may terminate. If the NO branch is taken, then the flow 300 may return to the stage 304 for another attempt at analysis of the OD 102.

FIG. 4 depicts an example of a system 400 including a wireless RF & IR remote 150 including microphone input 155 for configuring wireless speakers 160-L-160-S to optimize audio quality to match room acoustics. Here media player 100 is in wireless communication (e.g., 156, 426, 428, 430, 196) with various wireless devices including wireless speakers 160-L-160-S which emit sound 142-L-142-S that is received 442 by microphone 155 of remote 150. In this example, wireless speakers 160-L-160-S comprise left-L, right-R, center-C, left-rear-LR, right-rear-RR, and subwoofer-S channels of a 5.1 home theater system. Content from OD 102 the Cloud 190 or other source is wirelessly transmitted 426 to speakers 160-L-160-S to generate sound 142-L-142-S that may be used by remote 150 to tune room acoustics to improve quality of audio playback of content. For example, OD 102 may comprise Blu-Ray movie with a 5.1 surround sound track and HD video for display on HD display 170. User 450 may position remote 150 at a preferred location in a room where the content is to be experienced by the user 450 and the remote 150 in conjunction with media device 100 are operative to cause the wireless speakers 160-L-160-S to emit sounds 142-L-142-S, individually or in combination to be received 442 by microphone 155 and used to tune room acoustics to improve quality of audio playback of content as perceived by user 450 at the preferred location in the room. Parameters including but not limited to frequency response, sound delay between speakers 160, balance, volume, equalization, resonance control, or the like may be modified by media device 100 (e.g., via integrated NV controller 202) using the microphone 155 input on remote 150. DSP algorithms fixed in a non-transitory computer readable medium may be used to accomplish the acoustic tuning. Media device 100 and CE devices such as HD display 170 and CE Device 444 may be connected via a HDMI interface (e.g., using a HDMI cable) denoted as 210a and 410a. Content serving as well as CEC communications and control may be communicated over HDMI interface 210a and 410a. In that OD 102 comprises a Blu-Ray movie, based on the flow 300 of FIG. 3, media device 100 selects HD display 170 as the optimal CE device to display the video content on OD 102. Remote 150 may wirelessly communicate IR commands 458 to CE devices 444 and 170 to control operation of those devices, such as volume, mute, power on, power off, etc.

FIG. 5 depicts an example 500 of wireless communications between CE devices (170, 555), a wireless RF & IR remote 150, and media player 100. Here CE devices (170, 555) may include RF systems (172, 556) for wireless communications (568, 566) with media device 100 or other wireless systems, such as a WiFi router for example. Media device 100 may also be in wired communications with CE devices (170, 555) via connections 557 and 559 (e.g., via HDMI cables) and command, content, and control (e.g., CEC over HDMI) may be implemented using connections 557 and 559. However, in some examples, remote 150 may use IR commands to wirelessly control operation of CE devices, such as 170 and 555. To that end, each CE device (170, 555) may have a different set of IR command codes that it responds to denoted as 530 for 170 and 560 for 555. Remote 150 in addition to its RF capabilities to communicate with media device 100 may be configured to communicate over RF with media device to obtain IR command codes for the various CE devices in a system of user 550.

In example 500, user 550 initiates a first command 501 on remote 150 for CE device 170. Remote 150 transmits 510 over RF the requested command (e.g., power on) for device 170 to media device 100. Media device 100 includes data or has access to data for the IR codes for command 501 and transmits 540 the data for the IR code for command 501 to remote 150. Remote 150 outputs IR signal 530 with the correct IR code for command 501 to CE device 170 and CE device 170 acts on the command 501 (e.g., device 170 powers up).

Furthermore, in example 500, user 550 initiates a second command 502 on remote 150 for CE device 555 (e.g., a 400 Disc Blu-Ray Changer). The request is transmitted 520 to media device 100 and the appropriate IR code for the command 502 is transmitted 570 back to remote 150 which in turn transmits the IR code 560 for the command 502 to CE device 555 (e.g., load BD disc in tray slot 207 into optical drive for playback). As mentioned above, media player 100 may include the IR codes for CE devices internally in its systems (e.g., Flash Memory) or may have access to the IR codes from another source, such as Cloud 190 (e.g., a website, a data base, etc.). For example, IR codes for 170 may be internally stored in media device 100 and IR codes for CD 555 are wirelessly 196 obtained from Cloud 190.

FIG. 6 depicts an example flow diagram 600 for operation of a wireless RF & IR remote in conjunction with media player 100. At a stage 602 remote 150 issues one or more commands for a CE device via RF to the media device 100. At a stage 604 the media device determines if it has the IR codes for the commands requested by the remote 150. If the media device 100 does not have the IR codes a NO branch is taken and at a stage 606 the media device 100 obtains the codes from an appropriate source via a wired or wireless connection (e.g., Cloud 190) and the flow 300 resumes at a stage 608. If media device 100 has the codes a YES branch is take to the stage 608 where the media device 100 sends the IR codes for the commands via RF to the remote 150. At a stage 610 the remote 150 transmits the IR codes to the CE device using the remotes IR system (e.g., an IR LED and associated driver circuitry). Optionally, at a stage 612 a determination may be made as to whether or not commands for another CE device or additional commands for the same CE device are being requested by the remote 150 from the media device 100. If additional commands are requested, then a YES branch is taken and the flow 600 may resume at the stage 604. If additional commands are not requested, then a NO branch is taken and the flow 600 may terminate.

When media device 100 obtains the IR codes for CE devices from other than its own internal resources (e.g., Flash Memory 214), the media device may store newly acquired IR codes in its internal systems so that future requests from remote 150 are serviced by the media device 100 using those internal systems. For example, in a first request for IR codes for command 502 in FIG. 5, the media device may obtain the IR codes for command 502 and then store the IR code in Flash memory or other non-volatile memory and then subsequent request for the same command 502 are serviced directly from the media device's 100 internal memory and not from an external source such as Cloud 190. Storing IR codes for different CE devices may allow media device 100 to service command requests from remote 150 when the external sources for those codes are off-line or otherwise unavailable and may reduce latency between command requests and RF transmission of those requests from the media device 100 and remote 150. It should be noted that in FIGS. 5-6, the remote 150 need not internally store the IR codes from the CE devices it controls using its IR systems. The media device 100 services the command requests for the remote 150 from its internal memory resources and/or external sources.

FIG. 7 depicts one example 700 of an auto-run scenario. Here, user 450 inserts 702i a Blu-Ray (BD) disc 702 into optical drive 212 of media device 100. Using a process (e.g., flow 300 of FIG. 3) media device 100 detects and analyzes the content on BD 702 and determines the optimal CE devices for playback of the content on BD 702, which includes a multi-channel sound track (e.g., 5.1 or 7.1, etc.) and HD 1080p video, and the content is digital in format. Media device selects HD projector 770 as the optimal device in user 450 system for playback of the HD 1080p video and wireless speakers 160-L-160-S for playback of the multi-channel sound track. Furthermore, media device 100 recognizes that HD projector 770 works in conjunction with high resolution projection screen 780. CE devices 770 and 780 may be connected (770p, 780p) with media device 100 (e.g., via HDMI cables) and those connections may serve to activate those devices (e.g., power up 770 and lower projection screen 780). Alternatively, remote 150 may, at behest of user 450, request IR codes for commands to activate any CE devices that are enabled for IR control. IR signals 758 from remote 150 may be used to control CE devices 770 and/or 780 as described above in reference to FIGS. 5-6. In example 700, the auto-run capabilities of media device 100 obviate the need for user 450 to do anything other than selecting the source of content for media device 100 (e.g., inserting 702i the BD 702 into OD 212). Here, without having to use remote 150, media device 100 activates and directs content to CE devices 770 and 780.

### PWR5V Output Via Enable Regulator Controlled By PWR5V Switched Input

FIG. 8 depicts one example of a block diagram 800 for a conventional +5V Power Signal configuration for a HDMI interface. The HDMI physical layer interface standard uses an arrangement of “signal active” and “signal sensed” to initially determine the presence and activity of valid HDMI sources. In block diagram 800, a conventional HDMI configuration includes HDMI interface 801 which bridges HDMI source devices and sink devices as denoted by dashed lines 820 and 830 respectively. The HDMI source device side consists of a HDMI transmitter 805 and a supply and overcurrent protection device 803. The HDMI sink device side consists of a HDMI receiver 809 and EDID memory 807. Supply and overcurrent protection device 803 generates +5V power signal 804 in response to “signal active” and “signal sensed” conditions according to the HDMI standard.

FIG. 9 depicts one example of a block diagram 900 for an enable/disable +5V power signal triggered by an enable input for a HDMI interface that may be used in conjunction with media device 100. Here HDMI interface 901 bridges HDMI source devices and sink devices as denoted by dashed lines 920 and 930 respectively. A +5V power signal 904 is generated by circuitry in an active, current limited programmable voltage regulator 903 with an enable input 914, and activation of the +5V power signal 904 is not based solely on the HDMI standard although the +5V power signal 904 itself complies with the HDMI standard. Sensing and control circuit 911 receives as inputs other conditions 910 that circuit 911 senses and processes to determine whether or not to activate a +5V enable signal 912 that is electrically coupled with enable input 914 on programmable voltage regulator 903. Activation of the +5V enable signal 912 in response to the other conditions 910 inputs into circuit 911 generates a sourced +5V signal 916 that couples with HDMI interface 901 and is received as by the HDMI interface 901 and sink devices 907 and 909 as the HDMI standard +5V power signal 904. The active, current limited programmable voltage regulator 903 is operative to perform active current limiting on the sourced +5V signal 916 so that fault or overcurrent conditions may be protected against without having to use costly fuse devices. Enabling or disabling the sourced +5V signal 916 and by fiat the +5V power signal 904 upon sensing of other conditions 910 by circuitry 911 may include other conditions caused by media device 100 determining content on OD 102 or other source and generating signals include in 901 that are sensed by circuitry 911 to enable or disable the +5V enable signal 912 that is coupled with the enable input 914 of programmable voltage regulator 903. Activity on remote 150 (e.g., requesting IR codes for commands) may generate the other conditions that enable or disable the +5V enable signal 912.

FIG. 10 depicts one example of a flow diagram 1000 for a sourced +5V signal. At a stage 1002 the presence and/or activity of valid HDMI sources is determined. As at stage 1004 other conditions upon which the sourced +5V signal (e.g., 916) is to be enabled or disabled are sensed (e.g., via sense and control 911 based on other conditions 910 of FIG. 9). At as stage 1006 a determination is made to enable the sourced +5V signal based on the stages 1002 and/or 1004. If the sourced +5V signal is not to be enabled, then a NO branch is taken and the flow 1000 may return to the stage 1002. If the sourced +5V signal is to be enabled, then a YES branch is taken to a stage 1008 where current limiting may be applied to the sourced +5V signal (e.g., by active current limiting and programmable voltage regulator 903 of FIG. 9). At a stage 1012 the enable input (e.g. 914 of 903) is triggered (e.g., by +5V enable signal 912 going active) and the sourced +5V signal is generated and electrically couples with the +5V Power signal (e.g., 904 for the HDMI interface 901).

### Conversion of Analog and Digital Audio and Video Signals

FIG. 11 depicts analog and digital inputs and outputs 1100 for audio and video signals, a legend for the inputs and outputs, and a priority ranking for those inputs and outputs 1150. Inputs denoted as Input 1-Input 4 include a variety of analog and digital connections for audio and video signals that may be electrically coupled with media device 100. There may be more or fewer inputs than those depicted in FIG. 11. Similarly, a variety of audio and video signals in analog and digital formats may be outputs of media device 100 as denoted by Output in FIG. 11. There may be more than one Output on media device 100 and the one Output in FIG. 11 is just for purposes of explanation and the Output may include other types of output connectors than those depicted in FIG. 11. An Audio Legend and a Video Legend, denoted as 1150 in FIG. 11 depict a non-limiting variety of analog and digital signals than may be utilized by media device 100 as inputs and outputs. Some of the inputs Input 1-Input 4 and Output may serve to allow legacy devices (e.g., a VHS recorder or a Camcorder with S-Video outputs) to be connected with media device 100 and signals to/from those legacy devices may be processed and re-routed by media device 100 in the analog and/or digital signal domains. For example, S-Video input on Input 1 may be converted by media device into a digital format that is outputted on Output via the HDMI output, the optical SPDIF output, or the coaxial SPDIF output. As another example, Analog L/R Audio on Input 4 may be converted by media device 100 into coaxial SPDIF output (e.g., via a D/A converter) on Output.

Media device 100 may be configured to convert input streams (audio and video) that are either analog or digital, into output streams of digital video and digital and analog audio. The stream conversion capabilities allow media device 100 to be used with multiple older (e.g., legacy) audio/video sources and output from those legacy sources to be used with newer HDMI sink devices (e.g., a HDTV). Media device 100 may split the audio and video streams on a HDMI input (e.g., on Input 1-Input 4) so that the audio portion of the stream may be processed by an amplifier that is separate from the HDMI device that displays the video stream. The split out audio stream may be in digital format (e.g., over HDMI, SPDIF, or AES/EBU) and routed to an amplifier that receives audio signals in digital format, or the audio stream may be in analog format (e.g., over RCA, 3.5 mm jack, or XLR) and routed to an amplifier that receives analog audio inputs. The stream splitting allows for use of a HDMI only device with an HDMI television plus an external amplifier, which may be newer and digital capable, or older and analog only capable.

Media device 100 may convert S-Video or Composite Video, Component Video or DVI Video or HDMI Video plus Analog L/R Audio or Digital SPDIF Audio (coaxial or optical) into HDMI including integrated digital audio and video as well as analog L/R audio and digital SPDIF audio (coaxial or optical). Non-limiting examples of the inputs and outputs are depicted as 1100 in FIG. 11. For each input that has multiple audio and/or video sources, a priority is assigned to each of the audio/video sources as depicted by the Highest to Lowest priority for Video and Audio in legend 1150 of FIG. 11. Software and/or hardware in media device 100 may be configured to detect multiple audio and/or video signals on its inputs (e.g., Input 1-Input 4) and assign priority to those input signals based on a pre-assigned ranking, such as that depicted in legend 1150, for example. As one example, if the media device 100 detects a signal on both the S-Video and Composite Video inputs, then the S-Video signal will be selected based on its higher priority over Composite Video (see 1150).

FIGS. 12A-12C depict different examples of Analog and Digital input stream conversion. In FIG. 12A, example 1200 depicts a stream converter 1220 (e.g., part of A/V controller 202 of media device 100) receiving HDMI stream 1201 and splitting out of that stream HDMI video 1203 in digital format to HDMI sink device 1230 (e.g., a HDTV Plasma Screen) and a digital audio signal 1205 that is connected with a digital amplifier and/or A/V receiver 1240 that drives a speaker 1242 to generate sound 1244 (e.g., from a sound track or audio signal included in HDMI stream 1201). In FIG. 12B, example 1250 depicts an alternative scenario where stream converter 1220 splits HDMI stream 1201 into an analog audio signal 1255 output that is connected with an analog amplifier and/or A/V receiver 1270 that drives a speaker 1272 to generate sound 1274. In FIG. 12C, example 1280 depicts stream converter 1220 receiving a legacy stream 1281 and converting the legacy stream 1281 into a HDMI signal 1283 that is connected with a HDMI sink device 1290 (e.g., a HDMI HD Video Projector).

FIG. 13 depicts one example 1300 of input and output streams for a stream converter 1320 that accepts a variety of input streams including but not limited to: HDMI stream 1301; analog stream 1303; and digital stream 1305. Stream converter 1320 processes one or more of the input streams to generate one or more output streams including but not limited to: digital video 1302; digital audio 1304; analog audio 1306; digital and analog audio 1308; and HDMI 1310. Processing by stream converter 1320 may include the stream splitting as described above. One or more processors and/or algorithms in A/V controller 202 of media device 100 may be used to implement the stream converter 1320. For example one or more DSP's and associated signal processing algorithms (e.g., executable code fixed in a non-transitory computer readable medium) may be used to implement the stream converters described herein and hardware, software, and circuitry may be used to implement the stream splitting and conversion of signals into analog and/or digital formats (e.g., using A/D and D/A converters).

FIG. 14 depicts a diagram 1400 of a conventional remote control 1402 and a conventional host CE device 1420. Here, conventional remote control 1402 wirelessly communicates with conventional host CE device 1420 (e.g., a home theater receiver) using IR and/or RF signals 1406. Remote 1402 typically includes internal batteries 1404 (e.g., batteries 1404a and 1404b) as its power system. As such, remote 1402 comprises an auxiliary electronic device for conventional host CE device 1420. When remote 1402 is not needed, it typically is laid down somewhere and retrieved when needed again. Remote 1402 may often be lost or misplaced by its various users. Batteries 1404 are typically alkaline AA or AAA types and must be replaced after they are drained by use. Alternatively, Batteries 1404 may be rechargeable (e.g., nickel metal hydride or lithium ion) and may be removed from remote 1402 for recharging or optionally a remote dock and charger 1416 may be used to recharge batteries 1404 when the remote 1402 is mounted to the remote dock and charger 1416. Disadvantages to the conventional remote 1402 and charger 1416 include adding more clutter, the need to connect 1413 the charger 1416 to a fixed power source 1409 such as an AC outlet or a wall wart power supply that plugs into the fixed power source 1409. Furthermore, the power cord 1411 from conventional host CE device 1420 and the power supply for the charger 1416 will take up two plugs from the fixed power source 1409 and the user may desire to not have all available AC outlets used up by the conventional host CE device and its associated auxiliary electronic devices.

Many conventional host CE devices are used in combination with a remote or other accessory device that functions together with a main or host device. For example, a remote for a television is used to send commands (e.g., IR and/or RF) that enable remote operation of the television for tasks such as changing volume, changing channel, muting volume, and navigating menus, just to name a few. Typically, the host CE device with which the accessory electronic device is used does not provide a designated location for the storage of the accessory electronic device when the accessory electronic device is not being used. Additionally, most accessory electronic devices require a power source which traditionally consists of one or more batteries as described above in reference to FIG. 14. If the batteries are rechargeable, then a dedicated charging adapter (e.g., 1416 of FIG. 14) may be required and the adapter is typically separate from the host CE device. Typically the host CE device is powered directly by an electrical connection with a power grid, such as an AC electrical outlet in the user's home or office, for example. In some examples, a host CE device is battery powered (fixed or rechargeable batteries) and that battery system is separate from the power system of the accessory electronic device (e.g., remote 1402).

### Integrated Storage for an Accessory Device

FIG. 15 depicts one example 1500 of CE device 1520 including an integrated dock and remote control charger 1516 for a universal remote control 1502 that is an improvement over the conventional remote control and host CE device described above in reference to FIG. 14. Here, accessory/electronic device (e.g., remote 1502) and host CE device 1520 are configured to be integrated with each other with an integrated storage location 1516 for the accessory/electronic device 1502. The integrated storage location 1516 on the host CE device 1520 may include features and systems to allow for charging a battery system 1508 of the accessory/electronic device 1502 providing additional benefits and convenience to a user 1550, such as not requiring a separate charging dock, wall wart power supply, and another AC outlet connection to be made in additions to that of the host CE device 1320. The integrated storage location 1516 may be used to reduce clutter caused by the accessory/electronic device 1502 when not in use by user 1550, and the accessory/electronic device 1502 may easily be found by the user 1550 if it is positioned in the integrated storage location 1516, thereby preventing the accessory/electronic device 1502 from being lost or misplaced. Accordingly, the integrated storage location 1516 provides user 1550 of the accessory/electronic device 1502 with a dedicated, reserved location to store and optionally charge and/or operate the accessory/electronic device 1502. Adding features to allow charging of the accessory/electronic device 1502 while positioned in the integrated storage location 1516 eliminates the need for a separate power charging system for the accessory/electronic device 1502. Integrated storage location 1516 may be used to update software, firmware, software applications, IR and/RF codes or the like in accessory/electronic device 1502. For example, electrical connectors used for electrically coupling the accessory/electronic device 1502 with the integrated storage location 1516 (e.g., for charging the batteries 1508) may be used to perform the updates to memory in the accessory/electronic device 1502 (e.g., Flash memory).

Returning now to FIG. 15, for purposes of explanation, accessory/electronic device 1502 will be denoted as a remote control 1502 configured to wirelessly control host CE device 1520 using IR and/or RF signals 1506. A remote control is just one non-limiting example of what may comprise the accessory/electronic device 1502 and the accessory/electronic device 1502 may be another type of device. Remote 1502 may include internal storage for one or more internal batteries 1508 for its PWR systems and those batteries may be rechargeable. If the internal batteries 1508 are rechargeable, the remote 1502 may include electrical ports 1524 configured to make electrical contact with electrical ports 1524 positioned in an integrated dock and charger 1516 in host CE device 1520 and operative to supply electrical power to recharge the batteries 1508 when the remote 1502 is positioned in the integrated dock and charger 1516. Ports 1524 may also be used for software updates as described above. Further, host CE device 1520 may include circuitry for monitoring status and operational ability of the remote 1502 and/or its batteries 1508. For example, diagnostics on the remote 1502 and/or batteries 1508 may be performed using ports 1524 as electrical paths for signals and the like for performing the diagnostics. For example, rechargeable batteries 1508 may have a predetermined number of charge and discharge cycles that once exceeded result in reduced battery performance and ability to hold a charge. Via ports 1524, the host CE device 1520 may be configured to alert the user 1550 that the batteries 1508 need to be replaced with new batteries or give the user 1550 some indication of remaining battery life. Batteries 1508 may be implemented in a variety of formats and form factors such as AA, AAA, or types that are used in digital cameras, smartphones, cell phones, and the like.

Host CE device 1520 includes integrated dock and charger 1516 that may be implemented in a variety of ways that are not limited to the configuration depicted in FIG. 15. Integrated dock and charger 1516 may include an opening, portal, aperture, channel, hole, recess, groove, slot, cutout, or the like, generally denoted as feature 1522 in which the remote 1502 is positioned when docked with the host CE device 1520. Feature 1522 and/or remote 1502 may be configured so that the ports 1524 in the integrated dock and charger 1516 and ports 1524 on the remote 1502 make contact with one another when the remote 1502 is inserted 1507 into the integrated dock and charger 1516. Feature 1522 and/or remote 1502 may be configured (e.g., by their shape) so that the remote may only be inserted into the integrated dock and charger 1516 in one orientation that results in the ports 1524 making contact with one another. Remote 1502 may be a universal remote configured to operate the host CE device 1520 and other devices (not shown).

FIG. 16 depicts a universal remote control 1502 docked in an integrated dock and remote control charger 1516 (shown in dashed outline) and electrically coupled via ports 1524 with a power system 1620 of the host CE device 1520. Power system 1620 may be used to recharge batteries 1508 and may also be used to monitor status and health of the batteries 1508. Feature 1522 may be configured so that remote 1502 may still be accessible 1603 to the user 1550 when the remote 1502 is positioned in the integrated dock and remote control charger 1516. For example, the user 1550 may access controls 1605 and/or a display 1607 on the remote 1502 while docked. Host CE device 1520 may display information on display 1607 while the remote is docked and/or may responded to commands initiated by user 1550 via the controls 1605 or screen 1607 (e.g., a touch screen).

### Universal Remote Using IR and RF for Wireless Communication

FIG. 17 depicts one example 1700 of a conventional IR remote control 1720 transmitting IR commands 1725 to a conventional host CE device 1730. Here remote 1720 comprises a device which allows a user 1701 to remotely operate individual CE devices or multiple CE devices, typically be transmitting commands (e.g., IR Tx 1725) from the remote 1720 to the CE device 1730 to be controlled. In the conventional IR remote control scenario, the exchange between remote 1720 and CE device 1730 is a one way exchange in a direction of dashed arrow 1723 with the remote 1720 transmitting IR commands and the CE device 1730 receiving the IR commands.

With advances in RF technology for portable devices, remotes have evolved from using mostly IR signals to using RF signals or RF signals and IR signals for remote control of CE devices. RF signals avoid the line of sight, optical obstructions, and other anomalies that block or otherwise prevent IR signals from being received the intended CE device. FIG. 18 depicts one example 1800 of a universal remote 1820 in RF communication (1825, 1827) with a host CE device 1830. Here, RF communication (1825, 1827) between CE device 1830 and remote 1820 is bi-directional with both devices configured to transmit and receive RF signals that may include command and control information via a RF link. Remote 1820 may also include a uni-directional IR link as will be described below. By providing both RF and IR links, remote 1820 may maintain compatibility with legacy CE devices, such as TV's, VCR's, and the like that are remotely controlled only by IR codes transmitted uni-directionally from an IR remote and also provide RF remote capability for newer CE devices that use a bi-directional RF link to give users an enhanced functionality offered by a bi-directional RF link and expected legacy functionality of an IR link for the user's older CE devices.

In FIG. 18, user 1801 generates I/O 1822 on remote 1820 by pushing a button or touching an icon on a screen of the remote (e.g., a touch screen) and the remote send a RF command Send RF-R (where “-R” denotes from remote 1820) and that RF signal is received by RF enabled CE device 1830 as Receive RF-R, and this RF signal transmitted by 1820 is represented by 1827. Similarly, due to the bi-directional RF capabilities of 1820 and 1830, CE device 1830 may transmit a RF command Send RF-D (where “-D” denotes from CE device 1830) and that signal is received by remote 1820 as Receive RF-D, and this RF signal transmitted by 1830 is represented by 1825. Here, user 1801 may not only generate input on 1820 but also receive output (e.g. from 1830) that is displayed on remote 1820. Therefore, a display, indicator light, tactile surface, haptic feedback surface, speaker, or the like may signal the user 1801 as to status, command received, command executed, etc. in response to a RF command issued by remote 1820. Similarly, CE device 1830 may use its display or other systems to acknowledge actions taken, status, etc. Here, user 1801 takes advantage of remote 1820's ability to remotely control legacy devices (uni-directionally) and remotely control and interact (bi-directionally) with newer CE devices.

FIG. 19 depicts one example 1900 of a universal remote 1820 in bi-directional RF communication (1825, 1827) with a host CE device 1830 and uni-directional 1923 IR communication with a legacy CE device 1930. IR commands IR Tx 1925 is received IR Rx 1925 by legacy device 1930 which acts on the command sent without the ability to transmit an IR response, command, or other to remote 1820.

FIG. 20 depicts one example of a block diagram 2000 for a universal remote 2010 including an IR link 2020 and a RF link 2030 for communication with CE devices and Legacy devices as described above. Remote 2010 may include a display 2050 (e.g., touch screen), buttons or touch screen interface (IF) 2060, an ambient light sensor (ALS) 2080 for controlling brightness of display 2050 or backlighting functions of buttons 2060, detecting presence of a user, etc., a processor 2040 (e.g., a CPU, μP, or μC), and AN system 2090 for transducers such as a speaker 2091 and an integrated microphone 2093, LED's 2070 for indicators or the like. IR link 2020 is uni-directional (e.g., send IR only) and may only transmit IR Tx 2025 IR radiation (e.g., modulated) for controlling IR enabled CE devices. RF link 2030 is bi-directional (e.g., send and receive RF) and may both transmit TX and receive RX RF signals to/from RF enabled CE devices. Integrated microphone 2093 may be used for the room acoustic tuning described above.

Although the foregoing examples have been described in some detail for purposes of clarity of understanding, the above-described conceptual techniques are not limited to the details provided. There are many alternative ways of implementing the above-described conceptual techniques. The disclosed examples are illustrative and not restrictive.

What is claimed is:

1. A content driven media device system, comprising:
an all-in-one consumer electronics (CE) media player without internal amplifiers for amplifying audio content and including a first RF link for wirelessly communicating and controlling other RF enabled CE devices, and including an integrated dock and charging structure having a first port electrically coupled with a power system;
a universal remote control including an IR link, a second RF link, and an integrated microphone, the remote including a rechargeable power source and a second port electrically coupled with the rechargeable power source,
the integrated dock and charging structure operative to receive the universal remote control, the first port and the second port operative to make electrical contact with each other when the universal remote control is docked the integrated dock and charging structure, and the power system operative to charge the rechargeable power source when the universal remote control is docked;
at least one wireless speaker including a third RF link and internal amplifiers for amplifying audio content; and
a universal optical disc (OD) drive included in the all-in-one CE media player and operative to read and serve content on an OD inserted in the OD drive, wherein the first, second, and third RF links are in wireless communication with one another, and wherein the universal remote control controls the all-in-one CE media player and the at least one wireless speaker using the second RF link, and controls CE devices connected with the all-in-one CE media player with the IR link.

2. The system of claim 1, wherein the power system is operative to monitor and report on a selected one or more of status, condition, estimated lifetime, or remaining charge on the rechargeable power source when the universal remote control is docked.

3. The system of claim 1, wherein control functions on the universal remote control are accessible by a user when the universal remote control is docked.

4. The system of claim 1, wherein the rechargeable power source comprises one or more rechargeable batteries.

5. The system of claim 1, wherein the IR link uni-directionally sends commands over the IR link to IR capable legacy CE devices.

6. The system of claim 1, wherein the second RF link bi-directionally communicates over the second RF link with RF capable CE devices.

7. A content driven auto-run media device system, comprising:
an all-in-one consumer electronics (CE) media player without internal amplifiers for amplifying audio content and including a first RF link for wirelessly communicating and controlling other RF enabled CE devices, and including an integrated dock and charging structure having a first port electrically coupled with a power system;
a universal remote control including an IR link, a second RF link, and an integrated microphone, the remote including a rechargeable power source and a second port electrically coupled with the rechargeable power source,
the integrated dock and charging structure operative to receive the universal remote control, the first port and the second port operative to make electrical contact with each other when the universal remote control is docked the integrated dock and charging structure, and the power system operative to charge the rechargeable power source when the universal remote control is docked;
at least one wireless speaker including a third RF link and internal amplifiers for amplifying audio content; and
a universal optical disc (OD) drive included in the all-in-one CE media player and operative to read and serve content on an OD inserted in the OD drive, wherein the first, second, and third RF links are in wireless communication with one another, and
wherein the all-in-one CE media player, based on content on the OD that is inserted into the OD drive, automatically selects and controls wired and/or wirelessly connected media devices that are best suited for optimal playback of the content and serves the content to selected wired and/or wirelessly connected media devices.

8. The system of claim 7, wherein the power system is operative to monitor and report on a selected one or more of status, condition, estimated lifetime, or remaining charge on the rechargeable power source when the universal remote control is docked.

9. The system of claim 7, wherein control functions on the universal remote control are accessible by a user when the universal remote control is docked.

10. The system of claim 7, wherein the rechargeable power source comprises one or more rechargeable batteries.

11. The system of claim 7, wherein the IR link uni-directionally sends commands over the IR link to IR capable legacy CE devices.

12. The system of claim 7, wherein the second RF link bi-directionally communicates over the second RF link with RF capable CE devices.

13. An accessory media device, comprising:
a universal remote including a uni-directional IR link, a bi-directional RF link, a display, a rechargeable power source, and a processing unit,
the remote operative to wirelessly communicate with IR capable media devices, RF capable media devices or both, and
the remote operative to bi-directionally wirelessly communicate with the RF capable media devices and uni-directionally wirelessly communicate with the IR cable media devices.

14. The device of claim 13, wherein the remote is operative to receive over the RF link one or more of commands, control, or data transmitted by RF capable media devices.

15. The device of claim 13, wherein the remote is operative to transmit over the RF link one or more of commands, control, or data to RF capable media devices.

16. The device of claim 13 and further comprising:
a first port electrically coupled with the rechargeable power source.

17. The device of claim 16 and further comprising:
a second port electrically coupled with a power system of a media device and positioned in an integrated dock and charging structure of the media device,
wherein the integrated dock and charging structure is operative to receive the remote and to recharge the rechargeable power source by an electrical connection made between the first port and the second port when the remote is docked in the integrated dock and charging structure, and
wherein the electrical connection electrically couples the rechargeable power source with the power system.

18. The device of claim 17, wherein the display is accessible to a user when the remote is docked.

19. The device of claim 13, wherein the display comprises a touch screen display.

20. The device of claim 13, wherein the rechargeable power source is removable from the remote.
